(19) United States
(12) Patent Application Publication
(10) Pub. No.: US 2014/0287801 A1
(43) Pub. Date: Sep. 25, 2014

(54) PROTECTIVE SHELL AND CHARGING DEVICE ASSEMBLY FOR MOBILE PHONE

(71) Applicant: OXTI CORPORATION, Taipei (TW)

(72) Inventor: Chih Feng HO, Taipei (TW)

(73) Assignee: Oxti Corporation, Taipei (TW)

(21) Appl. No.: 13/846,957

(22) Filed: Mar. 19, 2013

(51) Int. Cl. H04B 1/38; H04M 1/02; H02J 7/00

(52) U.S. Cl. CPC H04B 1/3883; H02J 7/0042; H04M 1/0254; H04B 1/3888
USPC 455/573

(57) ABSTRACT

A protective shell and charging device assembly includes a shell having a base member for attaching to an electrical facility, an attaching device attached to the base member of the shell, a charging device, and another attaching device attached to the charging device for slidably engaging with the attaching device of the base member and for detachably attaching the charging device to the shell. The attaching devices include one or more magnetic attractive members for attracting or acting with each other and for detachably attaching the charging device to the shell. The shell includes a compartment formed by the base member, an upper member and a lower member for engaging with the mobile phone.

### BACKGROUND OF THE INVENTION

1. Field of the Invention

The present invention relates to a protective shell and charging device assembly for portable or mobile phones, and more particularly to a protective sheath or shell and charging device assembly including a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

2. Description of the Prior Art

Portable or mobile phones have been widely used today, and various kinds of typical charging devices or apparatuses or facilities have been developed and provided for charging the portable or mobile phones or for providing an electric power to the portable or mobile phones.

For example, U.S. patent application Ser. No. 2002/0147036 to Taguchi et al., and U.S. patent application Ser. No. 2007/0123315 to Williams J R. disclose two of the typical portable or mobile phones each comprising a typical charging device or apparatus or facility for electrically connecting or coupling to the portable or mobile phones or for providing an electric energy or power to the portable or mobile phones.

However, the typical charging devices or apparatuses or facilities are normally separated from the portable or mobile phones and received or carried in a pocket or purse or suitcase or the like, and may not be attached or mounted or secured or coupled or anchored to the portable or mobile phones such that the typical charging devices or apparatuses or facilities may not be carried with the users.

For example, when the previous batteries or power sources for the portable or mobile phones have been consumed, the users may have to open their pockets or purses or suitcases in order to search and find the required spare batteries or power sources or charging devices or apparatuses or facilities and then to electrically connect or couple the spare batteries or power sources or charging devices or apparatuses or facilities to the portable or mobile phones, and it thus takes time to search and find and couple the required spare batteries or power sources or charging devices or apparatuses or facilities to the portable or mobile phones.

Various kinds of typical protective shells or sheaths or shields or covers have also been developed and provided for attaching or mounting or securing onto the portable or mobile phone and for shielding and protecting the portable or mobile phone, however, the typical protective shells or sheaths or shields or covers may only be used for attaching or mounting or securing onto the portable or mobile phone, but may not be used for attaching or mounting or securing the other charging devices or apparatuses or facilities onto the portable or mobile phones.

The present invention has arisen to mitigate and/or obviate the afore-described disadvantages of the conventional portable or mobile phones and charging devices problems.

### SUMMARY OF THE INVENTION

The primary objective of the present invention is to provide a protective shell and charging device assembly including a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

In accordance with one aspect of the invention, there is provided a protective shell and charging device assembly for an electrical facility comprising a shell including a base member, a first attaching device including a first anchoring mechanism provided in the base member of the shell, a charging device, and a second attaching device including a second anchoring mechanism provided in the charging device and slidably engaged with the first anchoring mechanism of the base member of the shell and for detachably attaching and locking the charging device to the shell and thus for allowing the charging device to be slid or moved or adjusted relative to the protective shell between a releasing position where the charging device is just engaged onto the protective shell and a working or latching or locking position where the charging device is solidly and stably and firmly attached or secured or latched or locked onto the protective shell.

The first anchoring mechanism is preferably selected from a dovetail slot that is formed in the base member of the shell, and the second anchoring mechanism is preferably selected from a dovetail that is slidably engaged in or with the dovetail slot of the first anchoring mechanism of the first attaching device for allowing the charging device to be slid or moved or adjusted relative to the protective shell. The dovetail slot of the base member of the shell and the dovetail of the charging device include an L-shaped cross section.

The first attaching device includes at least one first magnetic attractive member engaged into the base member of the shell, and the second attaching device includes at least one second magnetic attractive member engaged into the charging device for acting with the at least one first magnetic attractive member of the base member of the shell, and for detachably attaching the charging device to the shell.

The shell includes a plug extended into the compartment of the shell for engaging with a socket opening of the electrical facility. The shell includes a compartment formed therein and defined by the base member, an upper member, a lower member, and two side members for attaching and receiving and engaging with the electrical facility.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a protective shell and charging device assembly in accordance with the present invention for a portable or mobile phone;

FIG. 2 is another exploded view of the protective shell and charging device assembly;

FIG. 3 is a perspective view of the protective shell and charging device assembly;

FIG. 4 is another perspective view similar to FIG. 3, illustrating the operation of the protective shell and charging device assembly;

FIG. 5 is a cross sectional view of the protective shell and charging device assembly, taken along lines 5-5 of FIG. 3; and

FIG. 6 is a plan schematic view illustrating the operation of the protective shell and charging device assembly.

### DETAILED DESCRIPTION OF THE PREFERRED EMBODIMENT

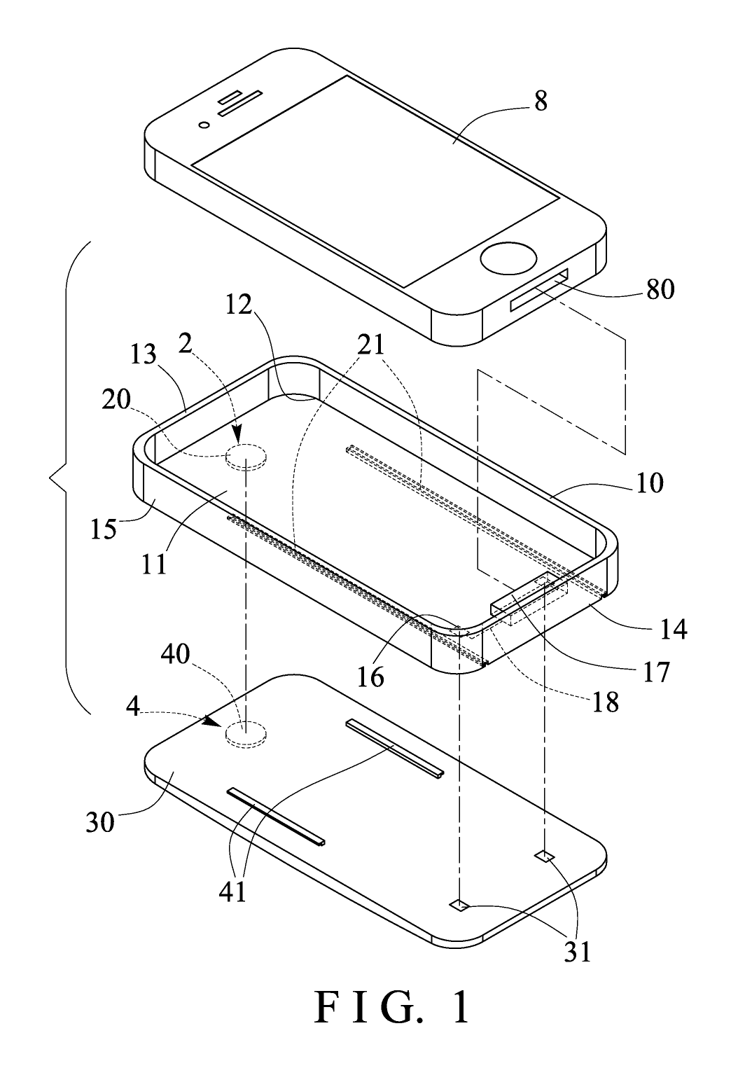

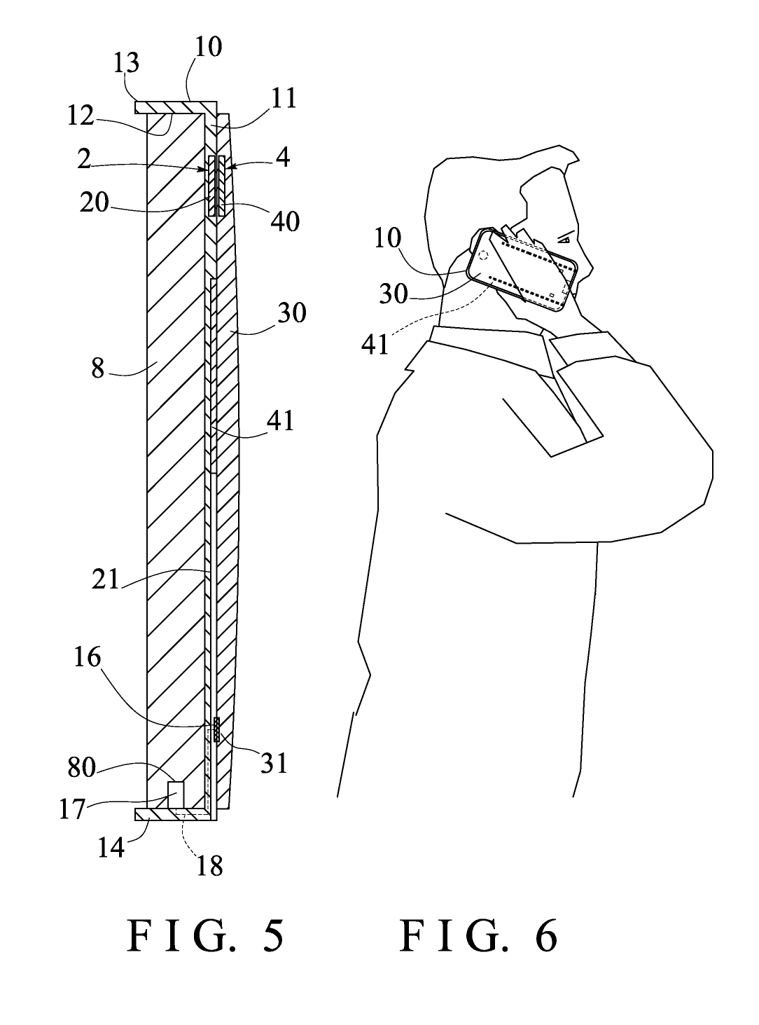

Referring to the drawings, and initially to FIGS. 1-5, a protective shell and charging device assembly in accordance with the present invention comprises a protective sheath or shield or shell 10 including a bottom or base wall or panel or board or plate or member 11 for attaching or mounting or securing onto or engaging with an electrical apparatus or facility 8, such as a portable or mobile phone 8 (FIGS. 1, 5), and/or including a chamber or compartment 12 formed in the protective sheath or shield or shell 10 and formed or defined by the base wall or panel or board or plate or member 11, an upper plate or member 13, a lower or bottom plate or member 14, and/or two opposite side plates or members 15 for receiving or engaging with or anchoring or retaining the portable or mobile phone 8 in the compartment 12 of the protective shell 10 with a force-fitted engagement or the like, in which the portable or mobile phone 8 includes a socket opening 80 formed or provided therein (FIG. 1).

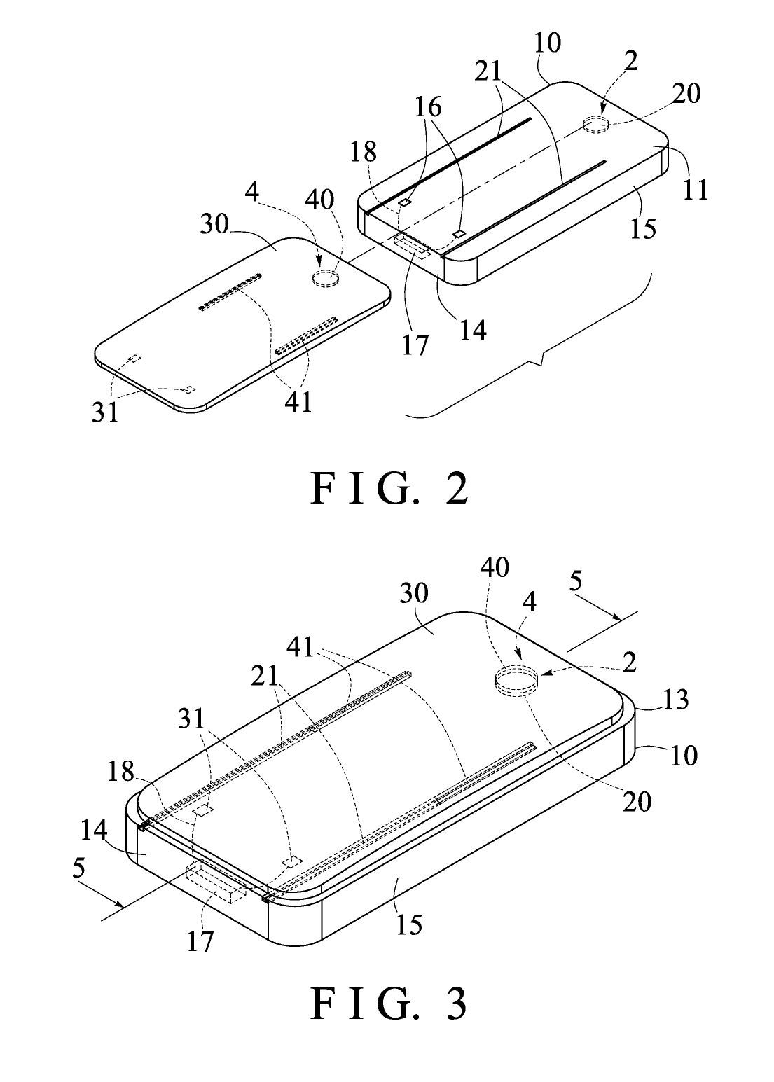

The protective shell 10 includes one or more (such as two) contacts or electrodes or terminals 16 disposed or provided or attached or mounted or secured or engaged therein, such as engaged in the base member 11 of the protective shell 10 and extended or located or faced or directed or exposed outwardly and rearwardly or away from the base member 11 (FIGS. 2 and 5), and includes a plug 17 formed or provided or attached or mounted or secured thereto, such as provided on the lower or bottom member 14 and extended into the compartment 12 of the protective shell 10 and electrically connected or coupled to the contacts or terminals 16 with electric cables or wires 18 or the like, for plugging or engaging into or with the socket opening 80 of the portable or mobile phone 8 and thus for electrically connecting or coupling to the portable or mobile phone 8 and for further solidly and firmly or stably anchoring or retaining or mounting or securing the portable or mobile phone 8 within the compartment 12 of the protective shell 10.

The protective shell 10 further includes an attaching or mounting or securing or engaging or anchoring or retaining device 2 having one or more (such as two) magnets or magnetic attractive members 20 disposed or attached or mounted or secured or engaged into the protective shell 10, particularly into the base member 11 of the protective shell 10 for attracting or acting with the portable or mobile phone 8 and for detachably attaching or mounting or securing or anchoring or engaging onto the mobile phone 8. The attaching device 2 and/or the protective shell 10 may further include another mounting or securing or engaging or retaining or anchoring member or element or mechanism 21, such as one or more (such as two) passages or grooves or tracks or trails or dovetail slots 21 formed in the base member 11 of the protective shell 10 (FIGS. 1 and 2).

It is to be noted that, without the attaching device 2, the protective shell 10 may also be attached or mounted or secured or disposed or engaged or anchored or retained or clamped onto the mobile phone 8 with the force-fitted engagement with or by the upper member 13 and the lower or bottom member 14, and/or the side members 15, for suitably shielding and protecting the mobile phone 8 and for preventing the mobile phone 8 from being scrubbed or scraped by the other objects or the like. The protective shell 10 may be made of soft or resilient materials selected from rubber, plastic, silicon, or composite materials or the like for easily and quickly and readily engaging onto the portable or mobile phone 8 and for softly or resiliently engaging with the portable or mobile phone 8.

The protective shell and charging device assembly further includes a portable electric power source or battery or charging apparatus or facility or device 30 having another attaching or mounting or securing or engaging or anchoring or retaining device 4 which includes one or more (such as two) magnets or magnetic attractive members 40 disposed or attached or mounted or secured or engaged into the portable charging apparatus or facility or device 30 for directing toward or aligning with the magnets or magnetic attractive members 20 of the attaching device 2 of the protective shell 10 and for attracting or acting with the magnets or magnetic attractive members 20 of the attaching device 2 of the protective shell 10 and for detachably attaching or mounting or securing the charging device 30 onto the protective shell 10.

Similarly, the attaching device 4 and/or the charging device 30 may further include another mounting or securing or engaging or anchoring or retaining members or elements, such as another mounting or securing or engaging or retaining or anchoring member or element or mechanism 41, such as one or more (such as two) protrusions or projections or tracks or trails or catches or latches or dovetails 41 extended outwardly from the charging device 30 for selectively and slidably engaging with the anchoring mechanism or dovetail slots 21 of the attaching device 2 and/or the protective shell 10; i.e., the anchoring mechanism or dovetails 41 of the attaching device 4 and/or the charging device 30 may be slidably meshed or engaged with the anchoring mechanism or dovetail slots 21 of the attaching device 2 and/or the protective shell 10 for detachably attaching or mounting or securing the charging device 30 onto the protective shell 10 and thus for allowing the charging device 30 to be easily or suitably carried with the users together with the protective shell 10.

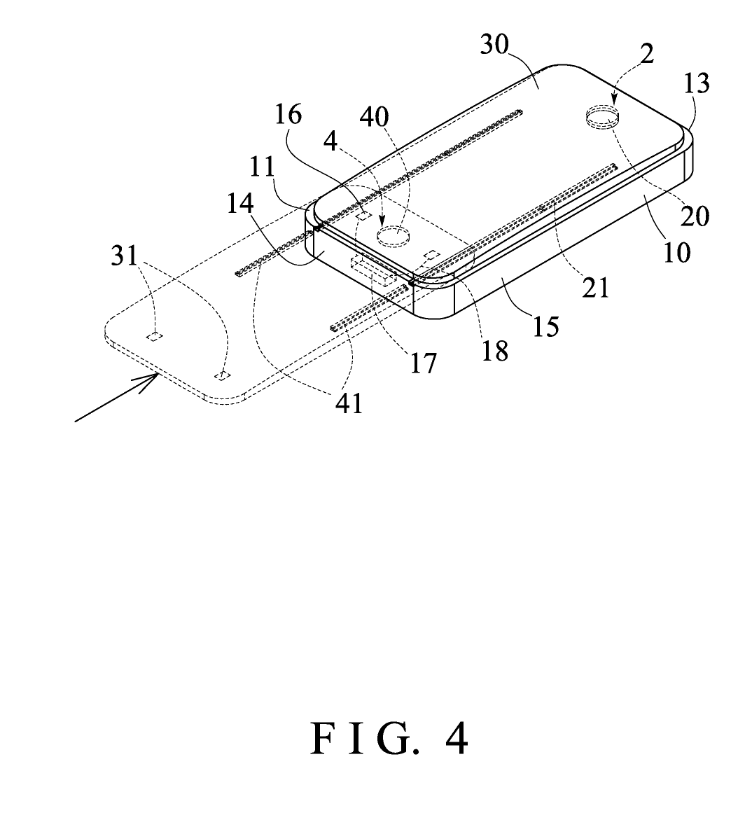

For example, the anchoring mechanism or dovetails 41 of the attaching device 4 and/or the charging device 30 each include an L-shaped structure or configuration or cross section, and the dovetail slots 21 of the attaching device 2 and/or the protective shell 10 also include a corresponding or identical L-shaped structure or configuration or cross section for snuggly fitting or engaging with the anchoring mechanism or dovetails 41 of the attaching device 4 and/or the charging device 30 and thus for allowing the charging device 30 to be slid or moved or adjusted relative to the protective shell 10 between a releasing position, as shown in dotted lines in FIG. 4, where the charging device 30 is just engaged onto the protective shell 10 and a working or latching or locking position as shown in solid lines in FIG. 4, where the charging device 30 is solidly and stably and firmly attached or secured or latched or locked onto the protective shell 10.

After the charging device 30 is attached or mounted or secured or anchored or retained or positioned or latched or locked to the protective shell 10 at the working or latching or locking position (FIGS. 3-6), the one or more (such as two) contacts or terminals or electrodes 31 of the charging device 30 may be aligned and contacted or engaged with the contacts or terminals 16 of the protective shell 10 for supplying the electric power or energy from the charging device 30 to the portable or mobile phone 8 with the plug 17, and thus for allowing the charging device 30 to be easily and readily and suitably used and carried with the users as best shown in FIG. 6. The structure or configuration and/or the function or operation of the battery or charging device 30 is not related to the present invention and will not be described in further details.

In operation, as shown in FIGS. 2-5, the protective shell 10 may be easily and quickly and readily attached or mounted or secured or anchored or retained to the mobile phone 8, or the mobile phone 8 may be easily and quickly and readily engaged with or into the compartment 12 of the protective shell 10, and the charging device 30 may be easily and quickly and readily attached or mounted or secured or anchored or retained to the protective shell 10 with the magnetic attractive members 20, 40 and/or the anchoring mechanisms 21, 41 of the attaching devices 2, 4 and/or of the protective shell 10 and the charging device 30, and thus for allowing the charging device 30 to be easily or suitably used and carried with the users (FIG. 6). The magnetic attractive members 20, 40 of the attaching devices 2, 4 include different poles for attracting or acting with each other.

Accordingly, the protective shell and charging device assembly in accordance with the present invention includes a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A protective shell and charging device assembly for an electrical facility comprising:
a shell including a base member,
a first attaching device including a first anchoring mechanism provided in said base member of said shell,
a charging device, and
a second attaching device including a second anchoring mechanism provided in said charging device and slidably engaged with said first anchoring mechanism of said base member of said shell and for detachably attaching and locking said charging device to said shell.

2. The protective shell and charging device assembly as claimed in claim 1, wherein said first anchoring mechanism is a dovetail slot formed in said base member of said shell, and said second anchoring mechanism is a dovetail slidably engaged with said dovetail slot of said first anchoring mechanism of said first attaching device.

3. The protective shell and charging device assembly as claimed in claim 2, wherein said dovetail slot of said base member of said shell and said dovetail of said charging device include an L-shaped cross section.

4. The protective shell and charging device assembly as claimed in claim 1, wherein said first attaching device includes at least one first magnetic attractive member engaged into said base member of said shell, and said second attaching device includes at least one second magnetic attractive member engaged into said charging device for acting with said at least one first magnetic attractive member of said base member of said shell, and for detachably attaching said charging device to said shell.

5. The protective shell and charging device assembly as claimed in claim 1, wherein said shell includes a plug extended into said compartment of said shell for engaging with a socket opening of the electrical facility.

6. The protective shell and charging device assembly as claimed in claim 1, wherein said shell includes a compartment formed therein and defined by said base member, an upper member, a lower member, and two side members for attaching and receiving and engaging with the electrical facility.
